(19) United States
(12) Patent Application Publication
(10) Pub. No.: US 2003/0233230 A1
(43) Pub. Date: Dec. 18, 2003

(54) System and method for representing and resolving ambiguity in spoken dialogue systems

(75) Inventors: Egbert Ammicht, Budd Lake, NJ (US); J. Eric Fosler-Lussier, Hillsborough, NJ (US); Alexandros Potamianos, Westfield, NJ (US)

Correspondence Address: HITT GAINES P.C., P.O. BOX 832570, RICHARDSON, TX, 75083, US

(73) Assignee: Lucent Technologies Inc., Murray Hill, NJ

(21) Appl. No.: 10/170,510

(22) Filed: Jun. 12, 2002

(51) Int. Cl. G10L 15/00

(52) U.S. Cl. 704/235

(57) ABSTRACT

A system for, and method of, representing and resolving ambiguity in natural language text and a spoken dialogue system incorporating the system for representing and resolving ambiguity or the method. In one embodiment, the system for representing and resolving ambiguity includes: (1) a context tracker that places the natural language text in context to yield candidate attribute-value (AV) pairs and (2) a candidate scorer, associated with the context tracker, that adjusts a confidence associated with each candidate AV pair based on system intent.

### CROSS-REFERENCE TO RELATED APPLICATION

The present application is related to U.S. patent application Ser. No. [ATTORNEY DOCKET NO. FOSLER-LUSSIER 2-28-5-4], entitled “System and Method for Measuring Domain Independence of Semantic Classes,” commonly assigned with the present application and filed concurrently herewith.

### TECHNICAL FIELD OF THE INVENTION

The present invention is directed, in general, to spoken dialogue systems and, more specifically, to a system and method for representing and resolving ambiguity in spoken dialogue systems.

### BACKGROUND OF THE INVENTION

In natural spoken dialogue systems for information retrieval applications, the understanding component of the system must be able to integrate various sources of information to produce a coherent picture of the transaction with the user. Some of this information, however, can be ambiguous in nature. The semantic content of some phrases can be ill-defined: “I want to fly next Saturday” could mean Saturday of this week or next; “Leave at six o'clock” may be reasonably interpreted as either 6 a.m. or 6 p.m.

Compounding this problem is that speech recognition error rates for natural spoken dialogues are currently relatively high and that mistakes made early in the processing chain can propagate throughout the system. Correction of such errors by the user introduces yet another form of ambiguity, especially since the error correction might itself be in error. Finally, a system must cope with the fact that users might explicitly change their minds, creating a third type of ambiguity.

To handle these different sources of ambiguity, the system designer must implement data structures and algorithms to efficiently categorize incoming information. One can, of course, construct ad hoc structures to hold ambiguous information (e.g., a specialized “date” class designed to disambiguate phrases such as “next Saturday”). However, the most advantageous goal is to characterize semantic ambiguity in a domain-independent fashion.

Therefore, what is needed in the art is a novel semantic representation and ambiguity resolution system. The system should take in spoken or typed natural language text, and derive candidate attribute-value (AV) pairs corresponding to the text. Such system should further be able to score candidate values based on supporting evidence for or against the candidate.

### SUMMARY OF THE INVENTION

To address the above-discussed deficiencies of the prior art, the present invention provides a system for, and method of, representing and resolving ambiguity in natural language text and a spoken dialogue system incorporating the system for representing and resolving ambiguity or the method. In one embodiment, the system for representing and resolving ambiguity includes: (1) a context tracker that places the natural language text in context to yield candidate attribute-value (AV) pairs and (2) a candidate scorer, associated with the context tracker, that adjusts a confidence associated with each candidate AV pair based on system intent.

The present invention therefore introduces an internal semantic representation and resolution strategy of a dialogue system designed to understand ambiguous input. These mechanisms are domain independent; task-specific knowledge is represented in parameterizable data structures. Speech input is processed through the speech recognizer, parser, interpreter, context tracker, pragmatic analyzer and pragmatic scorer. The context tracker combines dialogue context and parser output to yield raw AV pairs from which candidate values are derived. The pragmatic analyzer adjusts the confidence associated with each AV candidate based on system intent, e.g., implicit confirmation and user input. Pragmatic confidence scores are introduced to measure the dialogue managers confidence for each AV; MYCIN-like scoring is used to merge multiple information sources. Pragmatic analysis and scoring is combined with explicit error correction capabilities to achieve efficient ambiguity resolution. The proposed strategies greatly improve dialogue interaction, eliminating about half of the errors in dialogues from a travel reservation task.

In one embodiment of the present invention, the natural language text is selected from the group consisting of: (1) recognized spoken language and (2) typed text.

In one embodiment of the present invention, the context tracker models value ambiguities and position ambiguities with respect to the natural language text.

In one embodiment of the present invention, the candidate scorer analyzes raw data to adjust the confidence. In a related embodiment, the candidate scorer comprises a pragmatic analyzer that conducts a pragmatic analysis to adjust the confidence. In another related embodiment, the candidate scorer matches at least one hypothesis to a current context to adjust the confidence.

In one embodiment of the present invention, the system further includes an override subsystem that allows a user to provide explicit error correction to the system.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a prototype tree;

FIG. 2 illustrates a block diagram of a spoken dialogue system constructed according to the principles of the present invention;

FIG. 3 illustrates a flow diagram of a method of representing and resolving ambiguity in natural language text carried out according to the principles of the present invention; and

FIG. 4 illustrates a sample interaction in which mistakes that may occur in spoken dialogue in the context of the system of FIG. 2 are corrected.

### DETAILED DESCRIPTION

In the Background of the Invention section above, two sources of spoken language ambiguity were identified and described. To handle these different sources of ambiguity, a system designer must implement data structures and algorithms to categorize incoming information efficiently. As previously described, one can, of course, construct ad hoc structures to hold ambiguous information (e.g., a specialized “date” class designed to disambiguate phrases such as “next Saturday”).

However, the optimal goal is to characterize semantic ambiguity in a domain-independent fashion. In a system constructed according to the principles of the present invention, a parameterizable data structure (called the prototype tree) is developed from the ontology of the domain, and all other operations are defined based on this structure. While not all knowledge about a domain is encodable within the tree, this succinct encapsulation of domain knowledge allows generalized, domain-independent tree operations, while relegating the non-encodable specialized domain knowledge into a small set of task-dependent procedures.

A novel semantic representation and ambiguity resolution system and method will be presented herein. The system takes in spoken or typed natural language text, and derives candidate AV pairs (e.g., “Fly to Atlanta in the morning” produces <TOCITY>=Atlanta and <TIME>=morning).

Two types of ambiguities are modeled in the system: value ambiguities, where the system is unsure of the value for a particular attribute, and position ambiguities, where the attribute corresponding to a particular value is ambiguous. Candidate values are scored based on supporting evidence for or against the candidate. This evidence is provided by raw data, by pragmatic analysis and by matching a hypothesis to the current context. An override capability is also provided to the user based on a dialogue strategy of extensive implicit and explicit confirmation.

While the embodiment of the system to be illustrated and described is an automated travel agent capable of handling flight, car rental, and hotel arrangements (see, A. Potamianos, E. Ammicht, and H. K. Kuo, “Dialogue Management in the Bell Labs Communicator System,” in ICSLP, (Beijing, China), October 2000, both incorporated herein by reference), the algorithms described here are independent of the domain.

Semantic Representation of Ambiguity

Three hierarchical data structures are introduced for representing and instantiating domain semantics. The prototype tree represents the domain ontology, the notepad tree holds all raw values elicited or inferred from user input and the application tree holds the derived candidate attribute values.

The Prototype Tree

The basic data structure for representing values is a tree that expresses is-a or has-a relationship. The tree is constructed form the ontology of the domain: nodes encode concepts and edges encode relationships between concepts (see, J. Hobbs and R. Moore, Formal Theories of the Commonsense World. Norwood, N.J.: Ablex, 1985.; and S. Russell and P. Norvig, Artificial Intelligence: A Modern Approach. Upper Saddle River, N.J.: Prentice Hall, 1995, both incorporated herein by reference.)

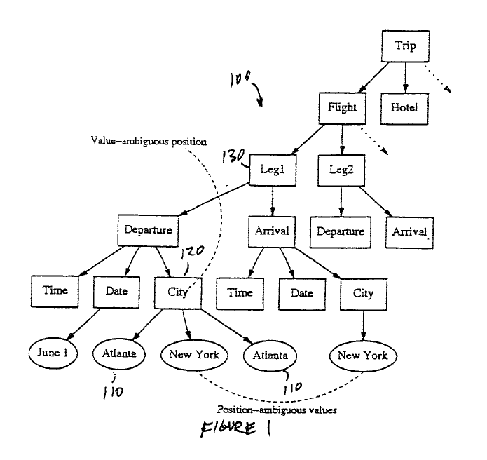

A trip, for example, comprises flights, hotels and cars. A flight, in turn, consists of legs, with departure and arrival dates, times and airports. Data are defined in terms of the path from the tree root to a leaf (the attribute), and the associated value. These paths can be uniquely expressed as a string consisting of a sequence of concatenated node names starting from the root, with a suitable separator such as a period. The attribute for the departure city Atlanta 110 shown in FIG. 1, for example, is given by “.trip.flight.leg1.departure.city.” This tree representation of the semantics—referred to as the prototype tree—is domain independent (see, Potamianos, et al., supra).

The prototype tree is an over-specification of the domain; not every concept in the tree will be explored during an interaction with the user. Information about the types of values a concept can take is also included in the prototype tree. Not all concepts have values (usually non-leaf nodes in the tree such as “departure”). Concepts that take values are referred to as “attributes.” Certain attributes can take multiple values, e.g., airline preferences, while others have to be unambiguously instantiated, e.g., departure city. Some attributes can be instantiated with a constraint rather than a value, e.g., arrival time=“before 5 p.m.” In addition to the semantic information, the prototype tree is overloaded with task and interface information such as the importance of each attribute for task completion. (See Potamianos, et al., supra, for further details.) More complex relationships between concepts, such as timeline consistency checking or inference about the values of an attributes are currently not encoded in the prototype tree and are handled by a separate semantic module.

The Notepad Tree

During a dialogue, the system extracts data values from user utterances and places them in the notepad tree, a tree structure that mirrors the prototype tree. Values retrieved from the user usually are not accompanied by complete references to the attribute (e.g., “I want to leave from Atlanta” yields a “departure.city” “Atlanta”). The system typically has a partial attribute, e.g., “.trip.flight.leg1,” that needs to be merged with “departure.city” to form a complete attribute “.trip.flight.leg1.departure.city.” The required context-tracking algorithms are further described below.

Ambiguities

Over several dialogue turns, AV pairs may be collected that share the same attribute. For example, two different departure city names may be collected, thereby introducing a value ambiguity. The cause, as discussed in the introduction, may be speech recognizer errors, parsing errors or ambiguous user language. Another possibility is an intentional change of the value by the user. A second kind of ambiguity occurs when the context does not uniquely identify the attribute of a value. For example, a city may be collected, but it may be unclear whether to classify it as a departure or an arrival city for a given flight, thereby introducing a position ambiguity. Such data will be entered in each of the corresponding positions in the notepad tree 100 as illustrated in FIG. 1. The notepad tree structure by itself cannot be used to keep track of position ambiguities, but must be augmented by an additional data structure that indexes position ambiguous nodes.

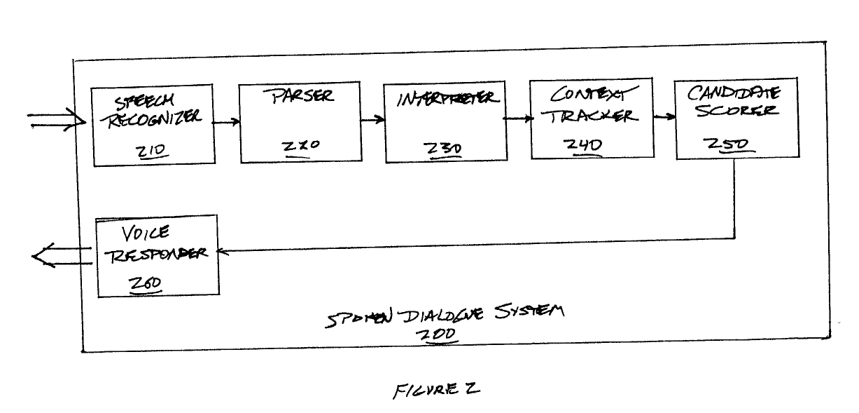

Before describing the operation of an exemplary spoken dialogue system, it is helpful to illustrate the system diagrammatically. Accordingly, turning now to FIG. 2, illustrated is a block diagram of a spoken dialogue system, generally designated 200, constructed according to the principles of the present invention. The spoken dialogue system 200 is illustrated as having a speech recognizer 210. The speech recognizer 210 receives an audio stream containing spoken language from a user (not illustrated) and recognizes the spoken language using techniques that are known to those skilled in the pertinent art.

Having been recognized, the words constituting the recognized spoken language are passed to a parser 220 that is coupled to the recognizer 210. The parser 220 parses the recognized spoken language. Next, an interpreter 230, that is coupled to the parser 220, further processes the recognized spoken language to yield natural language text. The natural language text is passed to a context tracker 240 that is coupled to the interpreter 230. The context tracker 240 places the natural language text in context to yield candidate AV pairs. The candidate AV pairs are then passed to a candidate scorer 250 that is coupled to the context tracker 240. The candidate scorer 250 adjusts a confidence associated with each candidate AV pair based on system intent to result in the best candidate AV pairs. A voice responder 260 is coupled to the candidate scorer 250. The voice responder 260 generates spoken language back to the user, perhaps requesting clarification or further information in the form of spoken language. Having generally described the spoken dialogue system 200, the discussion can now return to its operation.

The Application Tree

In most instances, it is required that the value of a given attribute be unique. Given a set of value of ambiguous entries in the notepad tree 100, an initial formulation would be to introduce equivalence classes for the data, combined with some disambiguation strategy to select a particular class. An instance in the class for the desired value could then be used. Referring to FIG. 1, for example, “Atlanta” 110 could be selected as the departure city 120 of the first leg 130. This approach rapidly proves untenable, however, since, for example, time specifications such as “in the morning” or “after 10 a.m.” do not have a useful transitivity relationship.

For the purposes of the application, it may be necessary to expand or to merge various values, e.g., merging times into appropriate time intervals, or expanding cities to a set of airports. Such derived values must be carefully chosen: distinct candidates should lead to different travel itineraries, while still being recognizable to the user as a direct consequence of some user input. Each of the resulting values becomes a distinct candidate for the unique value that is required. Candidates are maintained in a separate data structure, the application tree, similar to the notepad tree 100 used to hold the corresponding raw data.

This clear distinction between the raw data and the derived candidates greatly simplifies the formulation of the algorithms, and in particular the selection methods based on the scoring algorithms described below. They will require a suitable definition of consistency between candidate and raw data values.

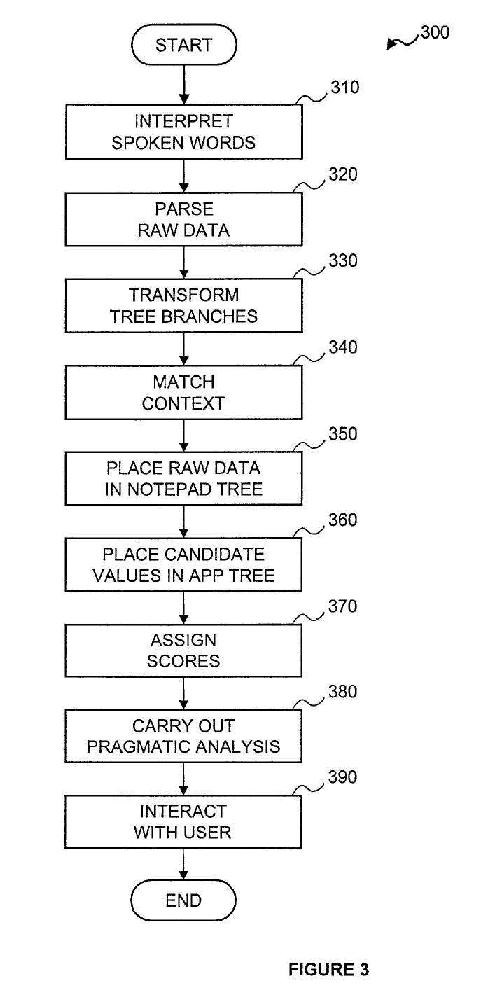

The following discussion is with reference to FIG. 3, which illustrates a flow diagram of a method, generally designated 300, of representing and resolving ambiguity in natural language text carried out according to the principles of the present invention.

To fill the notepad tree, spoken words may be interpreted to yield raw data from a spoken language input (in a step 310), or the raw data may be derived from typed input. The raw data are parsed (in a step 320) using a recursive finite-state parser (see, e.g., A. Potamianos and H. K. Kuo, “Speech understanding using finite state transducers,” in ICSLP, (Beijing, China), October 2000, incorporated herein by reference.) that acts as a semantic island parser; it iteratively builds up semantic phrase structures by transducing string patterns in the input into their semantic concepts (e.g., “Atlanta” is rewritten as <CITY>; “arriving in <CITY>” is subsequently transformed into <TOCITY>. The output of the parser is a set of tree branches (islands), which are then transformed, by a set of application-dependent routines in an interpreter (in a step 330), yielding a canonical form the notepad can use. For example, in the travel domain, cities are transformed into airport codes, date strings (e.g., “Tuesday”) are converted to the relevant date, and phrases like “first class” are changed into corresponding fare codes.

Context Tracking

The system maintains an expected context for every user response. This context is expressed as a path r from the root to some node of the prototype tree. Values extracted from a user utterance are in general associated with a partial attribute (i.e., a path l from some prototype tree node to a leaf). Derivation of the correct attribute for a given value requires matching the context to the partial attribute to form a complete path a from the root of the tree to the leaf (in a step 340). In the following discussion, the operator · is used to express concatenation.

In general, three types of matches should be considered:

i) exact match: the paths match up perfectly, i.e., a=r·l exists in the prototype tree. For example, given the context r “.trip.flight.leg1” and a datum with partial attribute l “.departure.city,” the complete path “.trip.flight.leg1.departure.city” is seen to exist in the tree in FIG. 1.

ii) interpolated match: the path must be interpolated, i.e., for some paths m, the attribute a=r·m·l exists in the prototype tree. For example, a context “.trip.flight” and a datum with partial attribute “departure.city” may be completed with the choice m=“.leg1”.

iii) overlap match: the paths overlap, i.e., there exists in the prototype tree. In this latter case, the general strategy chosen is to minimize the length of the path m. The overlapped substrings may not necessarily have to agree. For example, the context “.trip.flight.leg1.departure” may have to be shortened to “.trip.flight.leg1” so as to combine with “.arrival.city” to form a possible attribute. By shortening the context, the user is essentially allowed to override the system context.

An interpolation match can lead to position ambiguities. To control the generation of paths, the notion of extending a partial attribute l with a given path l′ prior to attempting a match is introduced. To do so, tuples of the form (l,l′,r′,γ) that are derived from the prototype tree are specified. These tuples form a parameterization of the following algorithm: given a context of the form r=r′m and a partial attribute l, use any of the other matching algorithms applied to r and the extended path l′·l. If successful, the parameter γ in [0,1] is used as a weight in the scoring algorithm (see Equation 2). This mechanism allows undesirable paths such as a “stopover.city” to be excluded, or one path to be selected over another. An example of the latter would be to favor an “arrival.date” for “.trip.cars,” i.e., the date when the car will be picked up, over a “.trip.cars.departure.date,” while favoring “.departure.date” for “.trip.flight,” i.e., the date of departure for a flight.

A further refinement of the context-tracking system is to allow for context changes while analyzing data from a given user utterance. These changes can be made unconditionally, or may be pushed on a stack, with previous contexts searched if the current context should fail withing the current utterance.

After raw data are processed by the parser, interpreter, and context tracker, they are placed in the notepad tree (in a step 350), and new candidate values, if any, are derived and placed in the application tree (in a step 360). Note that the formation of suitable candidates and the definition of the associated consistency relationship may be specific to each particular attribute, and hence application-dependent. In the illustrated system, position ambiguous data are not used to generate candidates. Instead, they result in the modification of the scores of existing candidates, and are made the subject of clarification dialogues where required.

Scoring Mechanism

Given multiple candidates for a given attribute, a sufficiently parameterized value selection mechanism should advantageously be amenable to training, such that a reasonable dialogue will result. To this effect, scores are assigned (in a step 370), i.e., MYCIN-style (see, e.g., E. Shortliffe, Computer-based Medical Consultation: MYCIN, New York, N.Y.: Elsevier, 1976; and D. Heckerman, “Probabilistic Interpretations for MYCIN's Certainty Factors,” in Uncertainty in Artificial Intelligence (L. Kanal and J. Lemmer, eds.), (Amsterdam: North Holland), pp. 11-22, 1986, both incorporated herein by reference) confidence factors s with range [−1,1] to every candidate, and two parameters σ₁ and σ₂ are defined to govern their selection. For a candidate value to be considered, its score should be sufficiently large, s≧σ₁≧0. If more than one candidate is present, the score difference Δs of the top two candidates should be sufficiently large, Δs≧σ₂≧0, for the top candidate to be selected. In the illustrated embodiment of the present invention, the system is trained to use the settings σ₁=0.25,σ₂=0.25.

The scores are modified by evidence e for or against the individual candidate value by:

$$S ( s , e ) = \{ \begin{matrix}s + ( 1 - s ) e , & s \geq 0 , e \geq 0 \\ s + ( 1 + s ) e , & s < 0 , e < 0 \\ \frac{s + e}{1 - min ( \vert s \vert , \vert e \vert )} , & otherwise ,\end{matrix} \qquad ( 1 )$$

Such evidence arises from individual data in the corresponding notepad positions, from the match-type and the number of attributes for a value obtained by the context-tracking algorithm, from direct and/or indirect confirmation based on pragmatic analysis of user responses to a given prompt, and from various rules and constraints that are specific to the system.

Notepad data may have any number of scores attached, (e.g., acoustic confidences and distribution frequencies). To use notepad data as evidence, we combine these scores to derive a single individual score p with range [0,1]. The actual combination function depends on the available score types, and the specific attribute of the datum. The strength of the evidence e for datum p used in the update for a candidate s is obtained from this score by:

$$e = \{ \begin{matrix}α p , & if p and s are consistent \\ β p , & otherwise ,\end{matrix} \qquad ( 2 )$$

where αε(0,1] and βε[−1,0] are constants derived from the context tracking algorithm. α=γ/n,β=−0.2γ/n may be used, where γ is the weight of the extended partial attribute context-tracking algorithm or 1, and n is the number of position ambiguous attributes found for the datum.

The scoring operation thus proceeds as follows:

i) as each datum is added to the notepad, its score is computed;

ii) the scores of all known candidates are updated based on this score;

iii) new candidates, if any, are produced;

iv) their score is computed based on the available raw data.

Note that the score of a candidate is independent of the order in which the scores are updated.

In the illustrated embodiment, each datum is inserted into the notepad with a default score p. However, in alternative embodiments, end-to-end confidence scores (see, e.g., K. Komatani and T. Kawahara, “Generating Effective Confirmation and Guidance Using Two-level Confidence Measures for Dialogue Systems,” in ICSLP, (Beijing, China), October 2000; and R. San-Segundo, B. Pellom, K. Hacioglu, W. Ward, and J. Pardo, “Confidence Measures for Dialogue Systems,” in Proc. ICSLP, (Salt Lake City), May 2001, both incorporated herein by reference) may take into account the word-level confidence that the speech recognition was correct, and the confidence of the interpreter (e.g., “next Friday” is more likely to mean Friday next week, rather than Friday this week).

Pragmatic Analysis

The above scoring machinery results in dialogues that depend on the scores associated with data extracted from user utterances, the careful tuning of the score combination functions and the parameters, and on the number of times a particular datum is found. Thus, the system remains vulnerable to misrecognitions and systematic errors. The user may be forced to specify a particular datum repeatedly to overcome a large positive score for some candidate.

To mitigate this vulnerability, individual data can be confirmed both directly and indirectly. To this end, the illustrated system carries out a pragmatic analysis of the user response to a particular system prompt (in a step 380). Individual candidates that may be in error are identified, and candidate scores are modified based on the derived evidence. The phrasing and the data presented in a prompt are designed, therefore, so that three predictions can be made about the user response: i) a possible confirmation (yes/no) of an explicit question asked by the system, ii) expected values and attributes that should appear if the presented data are correct and iii) unexpected values and attributes that may appear if the user objects to one or more of the data that were presented.

Data extracted from the user utterance is analyzed accordingly, and compared to the expectation. In the illustrated embodiment, responses that fully meet the expectation, but do not contain any unexpected values or attributes as evidence for the values being implicitly confirmed, are considered. Special cases, such as a “no” response to an explicit value ambiguity disambiguation question, (e.g., “Are you leaving from Atlanta or from New York?”) is taken as strong evidence against both values. Once again, system behavior will depend on careful tuning of these system actions. Conservative settings are likely to result in needless dialogue to reinforce the score of particular AV pairs. Aggressive settings allow the system to make less equivocal decisions based on the pragmatics, but also make it correspondingly more difficult for the user to correct errors. The settings must thus account for system capabilities, and in particular, for whether correction mechanisms are available to the user.

Correction Mechanisms

To allow for aggressive system settings, a capability for the user to talk about attributes directly, and to request specific actions from the system, is provided (and carried out in a step 390). In particular, information requests, e.g., “what is the departure city?” are allowed to ascertain the value for a specific attribute. Also allowed are clear requests, e.g., “clear the departure city,” to force the removal of all candidate values for a given attribute; freeze requests, e.g., “freeze the departure city,” to inhibit the system from further changing the value of a particular attribute; and change requests, e.g., “change Atlanta to New York,” “change the departure city to New York,” or even “not Atlanta, New York!,” implemented as a clear operation followed by creation of a candidate for the given attribute.

The implementation of these features uses the same context-tracking algorithm to derive the required attribute, with the added requirement that the resulting attribute must be unique. These algorithms are application independent.

Analysis of Experimental Results

Thirty-five dialogues were collected. This collection consists of interactions with a previous system (see Potamianos, et al., supra) which did not have pragmatic scoring, pragmatic analysis and correction mechanisms. Every dialogue was run through both the old system and a system constructed according to the principles of the present invention; at turns where the transactions diverged, system behavior was characterized based on knowledge of the system prompts and speech recognizer outputs, together with information about the internal system state.

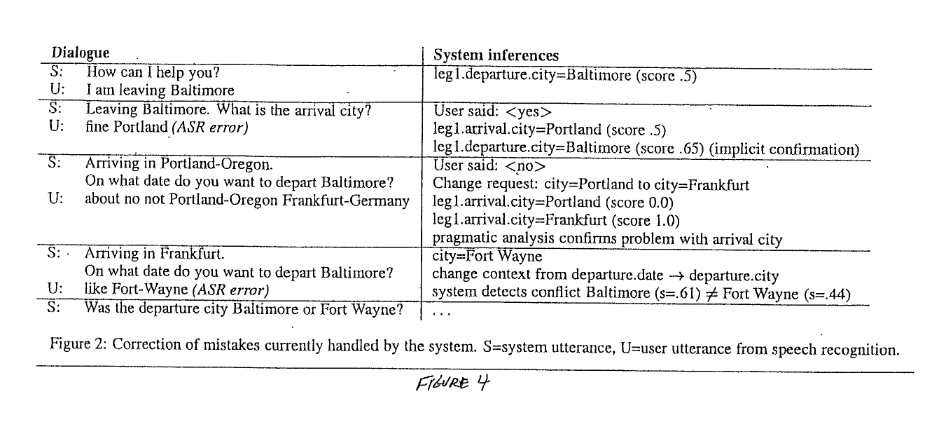

A sample interaction is shown in FIG. 4. Given 49 turns where the systems diverged, it was found that the system constructed according to the principles of the present invention improved in 25 cases, compared to only three cases where the older system appeared superior. The improvements were due to better parsing in ten cases, the introduction of scoring and pragmatic analysis in ten cases, and the interaction of both modules in three cases. In 21 cases, the dialogue diverged in ways that did not allow such a value judgment to be made.

The system and method described above represent a significant improvement over the prior art by directly representing ambiguities introduced both by system errors and user directions. This is accomplished by a representation that separates user input, task specification, recording of candidate values, and candidate selection into separate, but related, data structures. The addition of a pragmatic scoring mechanism, and the ability for the user to talk directly about attributes in correcting mistakes has improved several dialogues that were previously problematic.

Although the present invention has been described in detail, those skilled in the art should understand that they can make various changes, substitutions and alterations herein without departing from the spirit and scope of the invention in its broadest form.

What is claimed is:

1. A system for representing and resolving ambiguity in natural language text, comprising:
a context tracker that places said natural language text in context to yield candidate attribute-value (AV) pairs; and
a candidate scorer, associated with said context tracker, that adjusts a confidence associated with each candidate AV pair based on system intent.

2. The system as recited in claim 1 wherein said natural language text is selected from the group consisting of:
recognized spoken language, and
typed text.

3. The system as recited in claim 1 wherein said context tracker models value ambiguities and position ambiguities with respect to said natural language text.

4. The system as recited in claim 1 wherein said candidate scorer analyzes raw data to adjust said confidence.

5. The system as recited in claim 1 wherein said candidate scorer comprises a pragmatic analyzer that conducts a pragmatic analysis to adjust said confidence.

6. The system as recited in claim 1 wherein said candidate scorer matches at least one hypothesis to a current context to adjust said confidence.

7. The system as recited in claim 1 further comprising an override subsystem that allows a user to provide explicit error correction to said system.

8. A method of representing and resolving ambiguity in natural language text, comprising:
placing said natural language text in context to yield candidate attribute-value (AV) pairs; and
adjusting a confidence associated with each candidate AV pair based on system intent.

9. The method as recited in claim 8 wherein said natural language text is selected from the group consisting of:
recognized spoken language, and
typed text.

10. The method as recited in claim 8 wherein said placing comprises modeling value ambiguities and position ambiguities with respect to said natural language text.

11. The method as recited in claim 8 wherein said adjusting comprises analyzing raw data.

12. The method as recited in claim 8 wherein said adjusting comprises conducting a pragmatic analysis.

13. The method as recited in claim 8 wherein said adjusting comprises matching at least one hypothesis to a current context.

14. The method as recited in claim 8 further comprising allowing a user to provide explicit error correction to said system.

15. A spoken dialogue system, comprising:
a speech recognizer that recognizes spoken language received from a user;
a parser, coupled to said recognizer, that parses said recognized spoken language;
an interpreter that further processes said recognized spoken language to yield natural language text;
a context tracker that places said natural language text in context to yield candidate attribute-value (AV) pairs;
a candidate scorer, associated with said context tracker, that adjusts a confidence associated with each candidate AV pair based on system intent; and
a voice responder that generates spoken language back to said user.

16. The system as recited in claim 15 wherein said context tracker models value ambiguities and position ambiguities with respect to said natural language text.

17. The system as recited in claim 15 wherein said candidate scorer analyzes raw data to adjust said confidence.

18. The system as recited in claim 15 wherein said candidate scorer comprises a pragmatic analyzer that conducts a pragmatic analysis to adjust said confidence.

19. The system as recited in claim 15 wherein said candidate scorer matches at least one hypothesis to a current context to adjust said confidence.

20. The system as recited in claim 15 further comprising an override subsystem that allows a user to provide explicit error correction to said system.
